(19) United States
(12) Patent Application Publication
(10) Pub. No.: US 2026/0241319 A1
(43) Pub. Date: Aug. 20, 2026

(54) BIOSTATIC FILTER ASSEMBLY FOR AUTOMOTIVE HVAC SYSTEMS

(71) Applicant: Tesla, Inc., Austin, TX (US)

(72) Inventor: Scott Riley Thiessen, San Jose, CA (US)

(21) Appl. No.: 19/053,891

(22) Filed: Feb. 14, 2025

(51) Int. Cl. B01D 46/00; B01D 46/42; B01D 46/62; B60H 3/06

(52) U.S. Cl. CPC B01D 46/0038; B01D 46/0028; B01D 46/0041; B01D 46/0047; B01D 46/4263; B01D 46/62; B60H 3/0608; B01D 2273/30; B01D 2275/10; B01D 2279/40; B01D 2279/50; B01D 2279/65

(57) ABSTRACT

A filter assembly for an automotive vehicle can include a filter housing securable to a chassis of an automotive vehicle. The filter assembly can also include one or more layers of filter media secured to the filter housing. The one or more layers of filter media can be configured to receive an airstream therethrough and to filter particulate from the airstream before delivery of the airstream to a cabin of the automotive vehicle. The filter assembly can include soda ash applied to the one or more layers of filter media to raise a pH of the filter assembly that is exposed to the airstream.

### BACKGROUND

In the automotive industry, it is generally desirable for occupants of a vehicle to remain comfortable during transportation or use of the vehicle. To accommodate comfort, most vehicles include heating and cooling systems that are operable to maintain a comfortable internal temperature of the vehicle during use or operation of the vehicle. Traditional heating and cooling systems typically include a heat source (either a motor or a heater powered by a power source, such as one or more battery cells), a cooling system (such as a refrigeration-based cooling system), one or more fans or blowers, one or more filters, and multiple returns and discharges.

### BRIEF DESCRIPTION OF THE SEVERAL VIEWS OF THE DRAWINGS

Throughout the drawings, reference numbers may be re-used to indicate correspondence between referenced elements. The drawings are provided to illustrate examples of the subject matter described herein and not to limit the scope thereof.

FIG. 1 illustrates an isometric view of an automotive vehicle, according to some examples.

FIG. 2 illustrates a schematic view of a system of an automotive vehicle, according to some examples.

FIG. 3 illustrates a side cross-sectional view of a portion of the system, according to some examples.

FIG. 4 illustrates a side cross-sectional view of a portion of the system, according to some examples.

FIG. 5 illustrates a schematic view of one or more systems of an automotive vehicle, according to some examples.

### DETAILED DESCRIPTION

Automotive vehicles often include heating ventilation and air conditioning (HVAC) systems for maintaining a comfortable cabin temperature for occupants of the vehicle during all seasons of the year. As such, automotive HVAC systems often include both heating and cooling systems configured to heat or cool an airstream deliverable to the cabin for comfort cooling. To operate in an energy efficient manner and help bring in additional oxygen, outdoor air is often used for cooling or heating. However, outdoor air from an ambient environment often includes roadways traversed by vehicles and occupants of various transportation types.

The use or intake of outdoor air by an automotive HVAC system can therefore generate pollutants that may be desirable to filter prior to entering the cabin. It may also be desirable to filter other naturally occurring particulate such as dirt, dust, and pollen. Automotive HVAC systems often include one or more filters to help capture particulate or reduce its concentration before the air enters the cabin. However, as particulate builds in the filter, bacteria count can increase. As the bacteria (or other biological material) encounters moisture and other plant materials, the bacteria can grow at varying rates depending on the operating conditions of the car. Also, thermal cycling that can occur in normal use of a vehicle can select for species capable of generating endospores. For example, endospores can survive high temperatures when a vehicle is parked in the sun. As a result, the biologic material can emit gasses, such as acetate and butyrate, which can cause odor in the vehicle that can be unpleasant to occupants.

Some examples of this disclosure help to address these issues (among others) by providing a filter assembly that reduces odor, such as by including biostatic filter media to inhibit growth or multiplication of organisms within the particulate captured by the filter assembly, such as bacteria. These bacteria can be common in everyday pollutants and debris, but over time can concentrate in a filter and can generate a smell or odor. By including one or more inhibitors, such as soda ash or baking soda in or one the filter media, the media can be made alkaline or more basic and bacterial reproduction can be inhibited or reduced, effectively reducing or eliminating production of gasses by the bacteria such as acetate and butyrate, and thereby limiting odor generation from the filter assembly.

The above discussion is intended to provide an overview of subject matter of the present patent application. It is not intended to provide an exclusive or exhaustive explanation of the invention. The description below is included to provide further information about the present patent application.

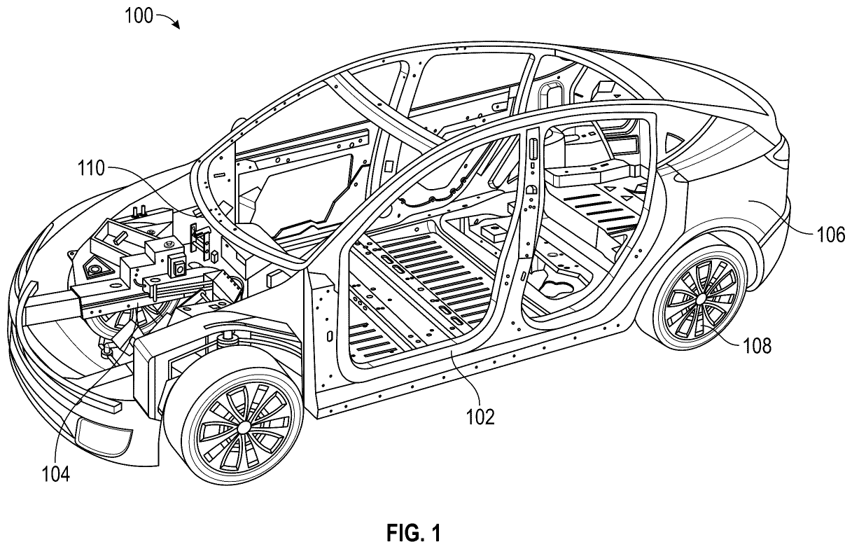

FIG. 1 illustrates an isometric view of an automotive vehicle 100, according to some examples. The automotive vehicle 100 can be a car, vehicle, automobile, or the like, operable to transport occupants or items over a road or other terrain. The automotive vehicle 100 can include a chassis 102, a drivetrain 104, panels 106, and wheels 108. The wheels 108 can engage with a road or terrain and can be configured to support the automotive vehicle 100. The chassis 102 can support the drivetrain 104, which can be connected to the wheels 108. The drivetrain 104 can be operable to drive the wheels 108 to rotate such as to move the automotive vehicle 100. The panels 106 can be connected to the chassis 102 and can help to reinforce the chassis 102 and improve drag or air resistance during transportation. As discussed in further detail below, the automotive vehicle 100 can also include a conditioning system 110, which can be configured to condition and deliver an airstream to a cabin of the automotive vehicle 100.

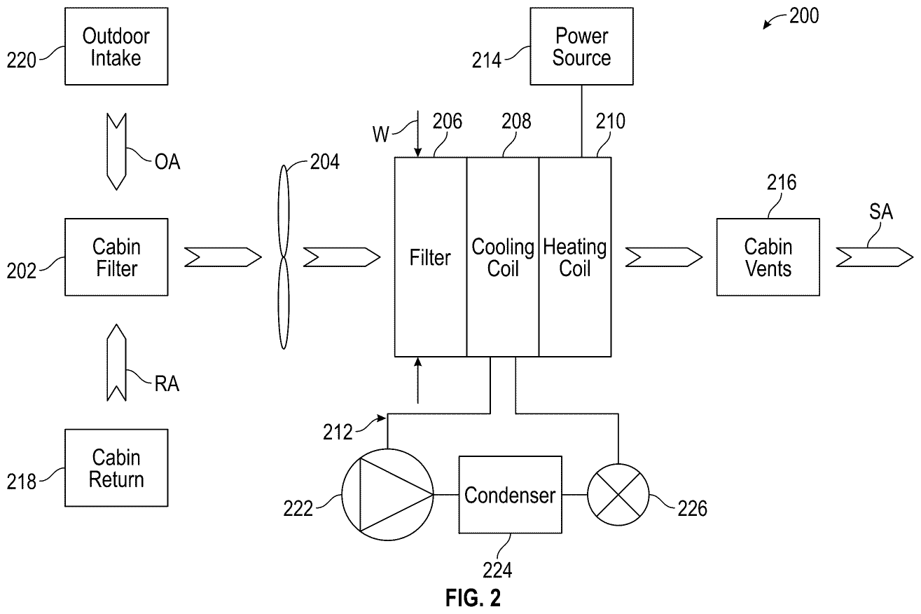

FIG. 2 illustrates a schematic view of a conditioning system 200 of an automotive vehicle, such as the automotive vehicle 100, according to some examples. The conditioning system 200 can be consistent with or can be the conditioning system 110. The conditioning system 200 can include a filter assembly 202, which can be a cabin filter or filter assembly configured to filter air deliverable to the cabin of the automotive vehicle 100. The conditioning system 200 can optionally include a filter assembly 206, which can be a second filter and can be configured similarly to the filter assembly 202, and can be located just upstream of a cooling coil 208. The filter assembly 202 or the filter assembly 206 can be secured to a chassis (e.g., the chassis 102) of the automotive vehicle 100 or can be secured to any component or subcomponent of the chassis 102 or the automotive vehicle 100. The conditioning system 200 can also include a fan 204 which can be a fan, blower, or the like such as a axial or centrifugal fan driven by a motor to generate an air stream. The conditioning system 200 can also include a return fan in some examples.

The cooling coil 208 can be part of cooling system 212, discussed further below, and can be configured to cool the airstream, such as the supply air stream SA. The cooling coil 208 can be located downstream of the filter assembly 202, the fan 204, and the filter assembly 206. In some examples, the cooling coil 208 can be located upstream of one or more of the filter assembly 202, the fan 204, and the filter assembly 206. The conditioning system 200 can also include a heating coil 210, which can be configured to heat the supply airstream SA prior to cabin discharge. The heating coil 210 can be or can include one or more resistive heating elements configured to generate heat from a power source 214 (e.g., one or more battery cells). In some examples, the heating coil 210 can be a fluid heating coil configured to transfer heat to the airstream using a heated fluid (such as engine or motor coolant or other fluid).

The conditioning system 200 can also include one or more discharge 216, which can be one or more vents or dampers configured to discharge the supply airstream SA to the cabin. The conditioning system 200 can also include one or more returns 218, which can be vents or dampers configured to receive a return airstream RA from the cabin to be recirculated through the conditioning system 200 for re-conditioning or can be exhausted from the cabin to an ambient environment. The conditioning system 200 can also include one or more outdoor air intake 220, which can be or can include one or more vents or dampers configured to receive an outdoor airstream OA from an ambient environment. The outdoor airstream OA and the return airstream RA can optionally mix upstream or downstream of the filter assembly 202. The conditioning system 200 can also be configured to receive air from only the returns 218 or the intake 220, which can be user-selected.

The cooling system 212 can be a system configured to reject heat from the cabin (e.g., via the airstream) to an ambient environment. The cooling system 212 can include a compressor 222 (or pump), which can be a refrigerant compressor connected to the cooling coil and configured to delivered compressed refrigerant or fluid to a condenser 224. The condenser 224 can be one or more coils or heat exchangers configured to reject heat from the refrigerant or fluid to the ambient environment. An expansion device 226 can be connected downstream of the condenser 224 and upstream of the cooling coil 208 and can be configured to expand cooled refrigerant from the condenser for the cooling coil 208. In other examples, the cooling system 212 can be a thermo-electric cooling system (e.g., a Peltier cooler).

In operation, one or more of the outdoor airstream OA and the return airstream RA can be filtered by the filter assembly 202 before entering the fan 204 where the fan 204 can be operable to motivate one or more of the return airstream RA, the outdoor airstream OA, and the supply airstream SA to flow. The cooling coil 208 and the heating coil 210 can be operable to heat or cool the airstream before delivery to the cabin at a desired temperature and humidity. One or more of the fan 204, the compressor 222, and other components of the conditioning system 200 can be in communication with a controller of the automotive vehicle 100, such as control systems 514, where the controller or control systems 514 can operate the cooling system 212 based on one or more setpoints received from a user or based on one or more conditions of the cabin or the ambient environment.

The filter assembly 206 and the filter assembly 202 can each be configured to filter particulate (such as dust, pollen, dirt, or the like) from the airstreams before delivery to the cabin. In doing so, the filter assembly 206 and the filter assembly 202 can retain particulate from the airstream, which can develop an odor over time. As discussed in further detail below, one or more of the filter assembly 202 and the filter assembly 206 can be configured to help mitigate such odors.

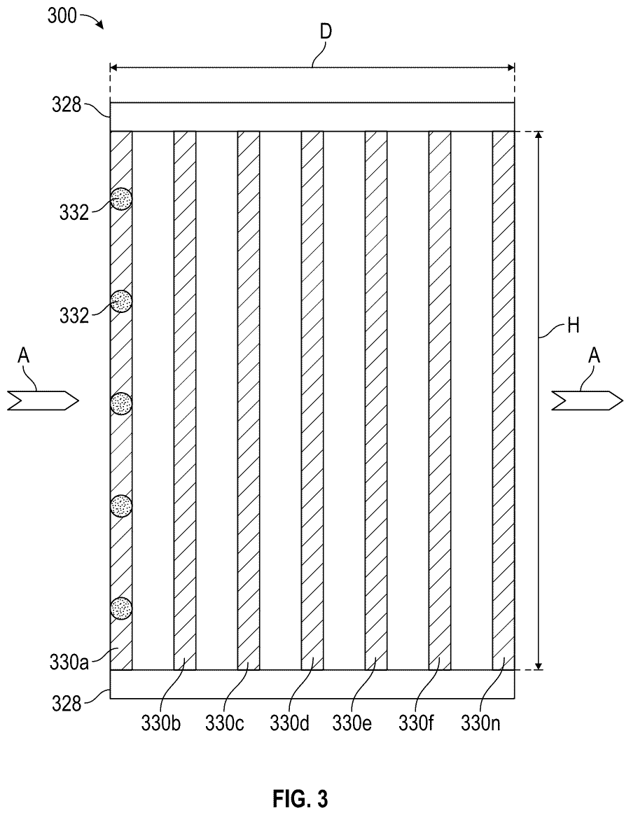

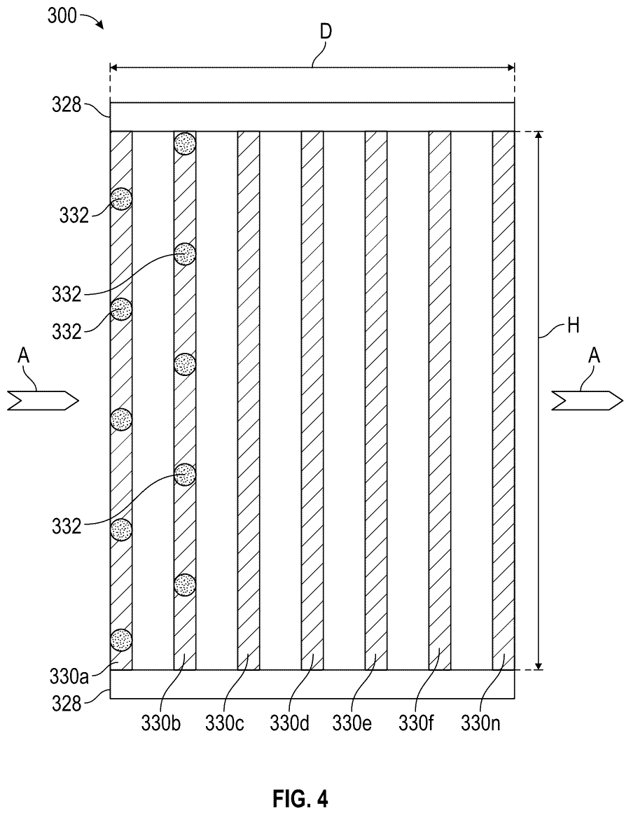

FIG. 3 illustrates side cross-sectional view of a filter assembly 300 of the system, according to some examples. FIG. 4 illustrates a side cross-sectional view of the filter assembly 300 of the system, according to some examples. FIGS. 3 and 4 are discussed together below. The filter assembly 300 can be similar to the filter assembly 202 or the filter assembly 206 or can be another filter assembly of the conditioning system 200 or can be located elsewhere in the automotive vehicle 100. The filter assembly 300 can generally be configured to filter particulate from an airstream A, which can be one or more of the outdoor airstream OA, the return airstream RA, and the supply airstream SA.

The filter assembly 300 can include a filter housing 328 and can include one or more media layers 330, such as media layer 330a through media layer 330n. The filter housing 328 can be a rigid or semi-rigid member (or members) made of materials such as one or more of metals, plastics, foams, elastomers, ceramics, composites, combinations thereof, or the like. The filter housing 328 can be configured to at least partially surround and support the media layers 330. The filter housing 328 can define an upstream opening and a downstream opening to receive the airstream A therethrough while the media layers 330 filter particulate from the airstream A. The filter housing 328 can define a height H, depth D, and width W (FIG. 2). The height H can be between 5 centimeters (cm) and 25 cm, such as 10 cm or the like. The width W can be between 10 cm and 50 cm, such as 25 cm or the like. The depth D can vary based on a number of layers. For example, the depth D can be between 5 cm and 50 cm, such as 20 cm, or the like. For example, one or more of the media layers 330 can have a height H between 20 centimeters and 30 centimeters and can have a width W between 5 centimeters and 15 centimeters.

The media layers 330 can be made of one or more filter materials such as polyester, fiberglass, polypropylene, polyethylene, charcoal, or the like. Each layer can be straight, pleated, or arranged in various shapes and sizes. Though 7 media layers are shown, fewer or more layers can be included, such as 1, 2, 3, 4, 5, 6, 8, 9, 10, 15, 20, or the like. Each of the media layers 330 can define pores or openings extending therethrough for allowing the passage of the airstream A therethrough while also filtering particulate from the airstream A.

The filter assembly 300 can also include a base particulate 332 applied, connected, attached, or bonded to or on one or more of the media layers 330, such as to raise a pH of the media layers 330. The base particulate 332 can be applied in dry particulate form, dry powder form, or the like, to one or more of the media layers 330. The base particulate 332 can be applied to the one or more of the media layers 330 in other ways. For example, the base particulate 332 can be integral to or embedded into one or more of the media layers 330. In other examples, one or more of the media layers 330 can be at least partially made of the base material or can give off, emit, or release the base particulate 332.

The base particulate 332 can be sodium carbonate (Na₂CO₃), such as soda wash, soda ash, or the like. In some examples, the base particulate 332 can be sodium bicarbonate (NaHCO₃), such as baking soda or bicarbonate of soda, or the like. In some examples, the base particulate 332 can be a mixture of any of the chemicals or components discussed above or below. In other examples, the base particulate 332 can be applied to the media layers 330 in a solution (e.g., an aqueous solution) such that the base particulate 332 dries to one or more of the media layers 330.

The base particulate 332 can be configured to have a pH between 8 and 12. The base particulate 332 can thereby be applied to the media layers 330 to increase or raise a pH of the filter assembly 300, such as to a pH around or between 9 and 11.5, such as a pH of 9, 9.5, 10, 10.5, 11, 11.5, or the like. A pH of the media layers 330 in this range can allow the base particulate 332 to react with biological material entering the filter assembly 300 and maintain the biological material (especially bacteria) in a biostatic or near biostatic environment, such as in one or more of the media layers 330 or within the filter housing 328, which can help to reduce or eliminate odor produced or generated by the biological material trapped by the filter assembly 300, while still operating a pH that presents little to no risk to occupants. In other words, the filter assembly 300 can help to maintain the bacteria in a dormant state of endospores, helping to limit or prevent odor production from the bacteria. Also, by using soda ash or baking soda, which are generally recognized as safe substances (GRAS), risk to occupants of the automotive vehicle 100 can generally be reduced or eliminated.

As shown in FIG. 3, in some examples, the base particulate 332 can be applied to an upstream layer, such as the media layer 330a so as to help ensure interaction between the base particulate 332 and incoming bacteria or biological material carried by the airstream A. As shown in FIG. 4, the base particulate 332 can be applied to the media layer 330a and the media layer 330b such as to help ensure interaction between the base particulate 332 and incoming bacteria or biological material. In other examples, the base particulate 332 can be applied to any number of the media layers 330.

By applying the base particulate 332 to the upstream layer or layers, the base particulate 332 can be carried by the airstream A to downstream layers, which can improve interaction between the base particulate 332 and the airstream A (and therefore between the base particulate 332 and biological material of the airstream A). For example, when the base particulate 332 is applied to only the media layer 330a (as shown in FIG. 3), the base particulate 332 can be carried to the media layer 330b by the airstream A, improving interaction between the base particulate 332 and the airstream or biological material within or from the airstream A.

An amount of base particulate 332, such as soda ash or the like, applied to the media layers 330 can be controlled to achieve a desired pH of the filter assembly 300, as discussed above, such as between 9 and 11.5. The amount of base particulate 332 applied can therefore vary based on a size and volume of the filter assembly 300 and of the media layers 330. In some examples, a volume of base particulate 332 applied can be between 0.5 grams and 5 grams. In some examples, a volume of the base particulate 332 applied can be between 1 gram and 2 grams, such as 1 gram, 1.5 grams, 2 grams, 2.5 grams, 3 grams, 3.5 grams, 4 grams, 4.5 grams, 5 grams, or the like.

A size of the particulate of the base particulate 332 can be selected or configured based on the material of the media layers 330, such as based on a pore or opening size of the media layers 330. For example, a size of the particulate can be between 0.1 micron and 10 micron (depending on the MERV rating and pore size of the filter assembly 300 and the media layers 330) to help ensure that the base particulate 332 can move the media layers 330 and that most of the base particulate 332 is retained within the filter assembly 300. In some examples, the base particulate 332 can be applied between the media layers 330 and can be sized to be larger than pores of the media layers 330 such that the base particulate 332 is encapsulated by the media layers 330 and cannot leave the filter assembly 300, ensuring interaction between the base particulate 332 and the airstream A. A size of the base particulate 332 can also be selected based on an ability of the base particulate 332 to dissolve into moisture that enters the media layers 330 from the airstream A.

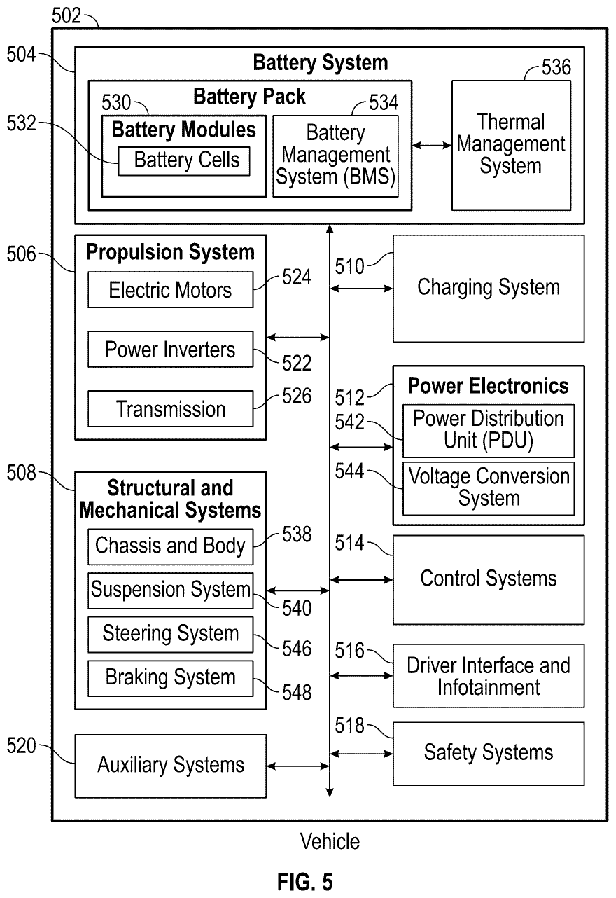

FIG. 5 is a system diagram illustrating an architecture of an electric vehicle (EV) 502, according to some examples. This diagram shows systems and sub-systems that can collectively enable the functionality and operational efficiency of the electric vehicle 10.

The vehicle 502 (which can be the automotive vehicle 100) can include a number of higher-level systems which are interconnected, including a battery system 504, a propulsion system 506, structural and mechanical systems 508, a charging system 510, power electronics 512, control systems 514, driver interface and infotainment 516, safety systems 518, and auxiliary systems 520.

The propulsion system 506 includes one or more electric motors 6, which can include traction motors for propulsion and motors for regenerative braking systems, convert electrical energy into mechanical energy. Power inverters 522, facilitate the conversion of DC power from the battery to AC power required by the electric motors 524. The propulsion system also includes a transmission 526, which can consist of a single-speed transmission or gearbox, channeling mechanical power to the vehicle's wheels.

The battery system 504 is composed of several battery modules 532, each housing multiple battery cells 534. These battery cells 534 can be based on various chemistries, including lithium-ion, lithium-polymer, or solid-state materials, each offering distinct advantages in terms of energy density, recharge cycles, and safety profiles.

A battery management system (BMS) 536 continuously monitors various parameters, such as voltage, current, and temperature of each of the battery cells 534 and battery modules 532, to prevent conditions that could lead to overcharging, deep discharging, or thermal runaway. The battery management system (BMS) 536 also manages the state of charge (SoC) and state of health (SoH) of the battery, ensuring that the energy is distributed during discharge and that the charging process is optimized for longevity and safety. Each battery management system (BMS) 536 employs algorithms to balance the charge across the cells and modules, correcting imbalances that can reduce the battery's overall capacity and lifespan.

Integrated with the battery system 504 is a thermal management system 538, which operatively maintains the battery cells 534 within specified temperature ranges. The thermal management system 538 employs temperature sensors to monitor the heat generated by the battery cells 534 during operation. Based on the data collected, it activates cooling and heating mechanisms to regulate the battery's temperature. Cooling methods can include air cooling, where ambient air is circulated around the battery modules, or liquid cooling, where a coolant is circulated through channels in or around the battery modules to absorb and dissipate heat. In colder environments, the thermal management system 538 can employ heating elements or use waste heat from the vehicle's systems to warm the battery cells, ensuring they operate efficiently even in low temperatures.

The charging system 510 operatively replenishes the stored energy within the battery system 504 of the electric vehicle 502. It supports various charging methodologies to ensure flexibility and convenience in energy restoration. The charging system 510 can encompass systems for both standard (Level 1 and Level 2) and fast charging (DC fast charging), facilitating a range of charging speeds to suit different user needs and infrastructure capabilities.

For standard charging, the charging system 510 includes an onboard charger for AC/DC conversion. This onboard charger converts the alternating current (AC) from the electrical grid or home outlets into direct current (DC) that can be stored in the vehicle's battery system 504. The onboard charger can, for example support Level 1 and Level 2 charging, with Level 1 charging using standard household outlets (208-120V) and Level 2 charging requiring a higher voltage source (208-240V), such as those found in dedicated charging stations or installed in residential garages.

For fast charging, the charging system 510 can incorporate a DC fast charging system, designed for rapid energy transfer directly to the vehicle's battery system 504, bypassing the onboard charger. DC fast charging stations supply high-voltage (e.g., 400V to 800V) direct current directly to the battery system 504.

Additionally, the electric vehicle 502 can be equipped with an auxiliary battery, such as a 12V lead-acid or lithium-ion battery can be tasked with powering the vehicle's low-voltage systems, including lighting, infotainment, electronic control units, and other ancillary components, ensuring their operation even when the main battery system is off or during the initial stages of charging when the main system's voltage might be too low for these tasks. This separation of power sources enhances the vehicle's electrical system reliability and ensures the availability of essential functions.

Structural and mechanical systems 508, including a chassis and body 540 and suspension system 542, provide the physical framework and support for the vehicle 502. The chassis and body 540 constitute the vehicle's primary structure, while the suspension system 542, which can include springs, shock absorbers (or dampers), and control arms, to provide a smooth and stable ride by mitigating road shocks and vibrations.

Power electronics 512, including a power distribution unit (PDU) 544 and a voltage conversion system 546, are responsible for the management and conversion of electrical power within the vehicle. The power distribution unit (PDU) 542, equipped with fuses and relays, distributes power to various vehicle systems, while voltage conversion devices of the voltage conversion system 544, such as DC/DC and AC/DC converters, adjust the voltage levels to meet the specific requirements of different components.

Control systems 514 facilitate the driver's command over the vehicle, with a steering system 546 and a braking system 548 as examples. The steering system 546, including a power steering motor, allows for precise directional control, whereas the braking system 548, which can feature disc brakes and an anti-lock braking system (ABS), enables deceleration and stopping.

The driver interface and infotainment 516 can support the driving experience by providing vehicle information and entertainment options through digital displays and multimedia systems. Connectivity features, such as Bluetooth and USB, further augment functionality. In some examples, the driver interface and infotainment 516 can include an interface for controlling the tilt of any of the seat modules discussed herein. For example, the infotainment 516 can include a graphic slider, buttons, or the like that can be user-selectable indications configured to adjust an amount that the bladder or bladders inflate or deflate to adjust a tilt of the seat.

Safety systems 518, designed to protect the vehicle's occupants, can include airbag systems and advanced driver-assistance systems (ADAS), for example. ADAS can use an array of sensors, cameras, radar, LiDAR, and/or ultrasonic devices to monitor the vehicle's surroundings, detect potential hazards, and execute or suggest corrective actions to prevent accidents and mitigate their impact.

ADAS can be categorized into different levels of self-driving capabilities, ranging from Level 0, where the human driver performs all driving tasks, to Level 5, which represents full automation with no human intervention required under any circumstances. Levels 1 and 2 focus on driver assistance and partial automation, respectively, where systems such as adaptive cruise control, lane-keeping assistance, and automatic emergency braking support the driver but do not replace them. Level 3, conditional automation, allows the vehicle to handle all aspects of driving in certain conditions, but requires the driver to be ready to take control when needed. Level 4, high automation, enables the vehicle to operate independently in most scenarios, though human override is still possible.

Examples of ADAS that contribute to these levels of automation include, but are not limited to, adaptive cruise control, which adjusts the vehicle's speed to maintain a safe distance from vehicles ahead; lane departure warning systems, which alert the driver when the vehicle begins to drift out of its lane; and automatic parking systems, which assist or take over control of the vehicle during parking maneuvers. More advanced systems, contributing to higher levels of automation, involve complex algorithms and machine learning capabilities to interpret sensor data, predict actions of other road users, and make real-time driving decisions.

Auxiliary systems 520 support the vehicle's functions and occupant comfort, with climate control and lighting systems as examples. The auxiliary systems 520 can also include windshield wipers etc.

As noted above, the systems of the vehicle 502 are communicatively connected. Communications between the interconnected systems within the automotive vehicle 100 are facilitated through a vehicle network architecture, employing both hardware and software components to ensure seamless data exchange and coordination. This network architecture can includes one or more vehicle communication buses, such as for example Controller Area Network (CAN), Local Interconnect Network (LIN), FlexRay, and Ethernet, which serve as the backbone for intra-vehicle communications.

The Controller Area Network (CAN) bus is a vehicle bus standard designed to allow microcontrollers and devices to communicate with each other within the vehicle 502 without a host computer. Such a network can support control communications between systems such as the battery system 504, propulsion system 506, and control systems 514, due to its high reliability and resistance to interference. A CAN bus can supports messages that ensure real-time control and monitoring of these systems.

For other communications, such as those involving the driver interface and infotainment 516 or auxiliary systems 520, a Local Interconnect Network (LIN) bus can be employed. LIN can provide a cost-effective, low-speed serial communication system for connecting intelligent sensors and actuaries. It can serve as a sub-network to the CAN bus, handling signals such as switch inputs and actuator outputs.

FlexRay technology offers a higher data rate compared to CAN and LIN, providing the necessary bandwidth for advanced control systems, including those required for autonomous driving functionalities within safety systems 518. Its deterministic nature and fault tolerance make it suitable for applications that require precise timing and synchronization, such as coordinating the actions of multiple control units in real-time.

Ethernet, with its high data transfer rate, can for example be adopted for diagnostics and infotainment applications within the vehicle 502. It supports the rapid transfer of large volumes of data, making it well suited for advanced driver assistance systems (ADAS), software updates, and multimedia streaming in the driver interface and infotainment 516 system.

Software protocols and application programming interfaces (APIs) built on top of these physical layers enable high-level communication and data exchange between systems. These protocols can define the rules for data format, timing, and error handling, ensuring that messages are correctly interpreted and acted upon by the receiving systems.

The following, non-limiting examples, detail certain aspects of the present subject matter to solve the challenges and provide the benefits discussed herein, among others.

Example 1 can include a filter assembly for an automotive vehicle, the filter assembly comprising: a filter housing securable to a chassis or substructure of an automotive vehicle; one or more layers of filter media secured to the filter housing, the one or more layers of filter media configured to receive an airstream therethrough and to filter particulate from the airstream before delivery of the airstream to a cabin of the automotive vehicle; and soda ash applied to the one or more layers of filter media to raise a pH of the filter assembly that is exposed to the airstream.

In Example 2, the subject matter of Example 1 can include wherein the soda ash is applied to the one or more layers of filter media in a dry powder or dry particulate form.

In Example 3, the subject matter of any one or more of Examples 1-2 can include wherein the pH of filter assembly is between 9 and 11.5.

In Example 4, the subject matter of Example 3 can include wherein pH of the filter assembly is configured to create a biostatic environment within the one or more layers of filter media.

In Example 5, the subject matter of any one or more of Examples 1-4 can include wherein the one or more layers of filter media has a height between 20 centimeters and 30 centimeters and has a width between 5 centimeters and 15 centimeters.

In Example 6, the subject matter of Example 5 can include wherein an amount of soda ash applied to the one or more layers of filter media is between 1 gram and 2 grams.

In Example 7, the subject matter of any one or more of Examples 1-6 can include wherein the soda ash is applied to an upstream layer of the one or more layers of filter media.

In Example 8, the subject matter of Example 7 can include wherein the soda ash is sized relative to a pore size of the one or more layers of media, to travel between the one or more layers of media.

In Example 9, the subject matter of any one or more of Examples 1-8 can include wherein the soda ash is sized to dissolve into moisture from the airstream.

In Example 10, the subject matter of any one or more of Examples 1-9 can include wherein the filter assembly is a cabin filter configured to filter outside air entering the cabin.

In Example 11, the subject matter of any one or more of Examples 1-10 can include wherein the filter assembly is a conditioning filter configured to filter the airstream upstream or downstream of a cooling component or heating component of the automotive vehicle.

Example 12 can include an air conditioning system for an automotive vehicle, the air conditioning system comprising: a fan connected to a chassis of the automotive vehicle and configured to generate an airstream through a cabin of the automotive vehicle; a heating system or cooling system connected to the chassis and configured to, respectively, heat or cool the airstream; and a filter assembly located in the airstream, the filter assembly comprising: a filter housing securable to a chassis of an automotive vehicle; one or more layers of filter media secured to the filter housing, the one or more layers of filter media configured to receive an airstream therethrough and to filter particulate from the airstream before delivery of the airstream to a cabin of the automotive vehicle; and soda ash applied to the one or more layers of filter media to raise a pH of the filter assembly that is exposed to the airstream.

In Example 13, the subject matter of Example 12 can include wherein the filter assembly is a cabin filter configured to filter outside air entering the cabin.

In Example 14, the subject matter of any one or more of Examples 12-13 can include wherein the filter assembly is a conditioning filter configured to filter the airstream upstream or downstream of a cooling component or heating component of the automotive vehicle.

In Example 15, the subject matter of Example 14 can include the heating system or cooling system comprising: a heating coil downstream of the filter assembly, the heating coil configured to deliver heat to the airstream.

In Example 16, the subject matter of Example 15 can include the heating system or cooling system comprising: a cooling coil downstream of the filter assembly, the cooling coil configured to receive heat to the airstream.

In Example 17, the subject matter of any one or more of Examples 12-16 can include wherein the soda ash is applied to the one or more layers of filter media in a dry powder or dry particulate form.

In Example 18, the subject matter of Example 17 can include wherein the pH of filter assembly is between 9 and 11.5.

In Example 19, the subject matter of Example 18 can include wherein pH of the filter assembly is configured to create a biostatic environment within the one or more layers of filter media.

In Example 20, the subject matter of any one or more of Examples 12-19 can include wherein the soda ash is applied to an upstream layer of the one or more layers of filter media.

In Example 21, the apparatuses or method of any one or any combination of Examples 1-20 can be configured such that all elements or options recited are available to use or select from.

The above detailed description includes references to the accompanying drawings, which form a part of the detailed description. The drawings show, by way of illustration, specific examples that can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5). Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The above description is intended to be illustrative, and not restrictive. For example, the above-described examples (or one or more aspects thereof) can be used in combination with each other. Other examples can be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment. The scope of the examples should be determined with reference to the appended claims, along with the full scope of equivalents to which such claims are entitled.

What is claimed is:

1. A filter assembly for an automotive vehicle, the filter assembly comprising:
a filter housing securable to a chassis or substructure of an automotive vehicle;
one or more layers of filter media secured to the filter housing, the one or more layers of filter media configured to receive an airstream therethrough and to filter particulate from the airstream before delivery of the airstream to a cabin of the automotive vehicle; and
soda ash applied to the one or more layers of filter media to raise a pH of the filter assembly that is exposed to the airstream.

2. The filter assembly of claim 1, wherein the soda ash is applied to the one or more layers of filter media in a dry powder or dry particulate form.

3. The filter assembly of claim 1, wherein the pH of filter assembly is between 9 and 11.5.

4. The filter assembly of claim 3, wherein pH of the filter assembly is configured to create a biostatic environment within the one or more layers of filter media.

5. The filter assembly of claim 1, wherein the one or more layers of filter media has a height between 20 centimeters and 30 centimeters and has a width between 5 centimeters and 15 centimeters.

6. The filter assembly of claim 5, wherein an amount of soda ash applied to the one or more layers of filter media is between 1 gram and 2 grams.

7. The filter assembly of claim 1, wherein the soda ash is applied to an upstream layer of the one or more layers of filter media.

8. The filter assembly of claim 7, wherein the soda ash is sized relative to a pore size of the one or more layers of media, to travel between the one or more layers of media.

9. The filter assembly of claim 1, wherein the soda ash is sized to dissolve into moisture from the airstream.

10. The filter assembly of claim 1, wherein the filter assembly is a cabin filter configured to filter outside air entering the cabin.

11. The filter assembly of claim 1, wherein the filter assembly is a conditioning filter configured to filter the airstream upstream or downstream of a cooling component or heating component of the automotive vehicle.

12. An air conditioning system for an automotive vehicle, the air conditioning system comprising:
a fan connected to a chassis of the automotive vehicle and configured to generate an airstream through a cabin of the automotive vehicle;
a heating system or cooling system connected to the chassis and configured to, respectively, heat or cool the airstream; and
a filter assembly located in the airstream, the filter assembly comprising:
a filter housing securable to a chassis of an automotive vehicle;
one or more layers of filter media secured to the filter housing, the one or more layers of filter media configured to receive an airstream therethrough and to filter particulate from the airstream before delivery of the airstream to a cabin of the automotive vehicle; and
soda ash applied to the one or more layers of filter media to raise a pH of the filter assembly that is exposed to the airstream.

13. The air conditioning system of claim 12, wherein the filter assembly is a cabin filter configured to filter outside air entering the cabin.

14. The air conditioning system of claim 12, wherein the filter assembly is a conditioning filter configured to filter the airstream upstream or downstream of a cooling component or heating component of the automotive vehicle.

15. The air conditioning system of claim 14, the heating system or cooling system comprising:
a heating coil downstream of the filter assembly, the heating coil configured to deliver heat to the airstream.

16. The air conditioning system of claim 15, the heating system or cooling system comprising:
a cooling coil downstream of the filter assembly, the cooling coil configured to receive heat to the airstream.

17. The air conditioning system of claim 12, wherein the soda ash is applied to the one or more layers of filter media in a dry powder or dry particulate form.

18. The air conditioning system of claim 17, wherein the pH of filter assembly is between 9 and 11.5.

19. The air conditioning system of claim 18, wherein pH of the filter assembly is configured to create a biostatic environment within the one or more layers of filter media.

20. The air conditioning system of claim 12, wherein the soda ash is applied to an upstream layer of the one or more layers of filter media.
